(19) United States
(12) Patent Application Publication
(10) Pub. No.: US 2026/0015491 A1
(43) Pub. Date: Jan. 15, 2026

(54) RUBBER COMPOSITION FOR TIRE SIDE WALL AND PNEUMATIC TIRE

(71) Applicant: Toyo Tire Corporation, Itami-shi (JP)

(72) Inventor: Takayoshi Kimura, Itami-shi (JP)

(73) Assignee: Toyo Tire Corporation, Itami-shi (JP)

(21) Appl. No.: 19/247,491

(22) Filed: Jun. 24, 2025

(30) Foreign Application Priority Data
Jul. 11, 2024 (JP) 2024-111420

(51) Int. Cl. C08L 7/00; B60C 1/00; C08K 3/04; C08K 5/09; C08L 9/00

(52) U.S. Cl. CPC C08L 7/00; B60C 1/0025; C08K 3/04; C08K 5/09; C08L 9/00

(57) ABSTRACT

A rubber composition for tire side wall comprising, per 100 parts by mass of a rubber component containing at least a diene-based rubber, 0.2 to 7 parts by mass of a compound represented by the following general formula (1):

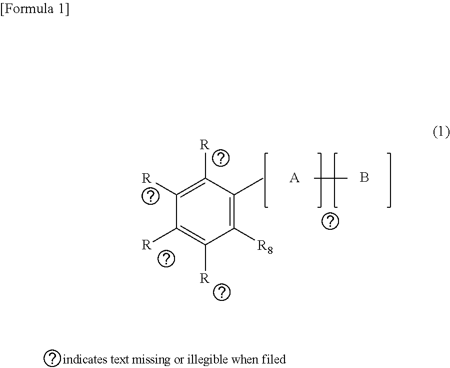

wherein at least one of R₁ to R₅ is an —OH group or an —OCH₃ group and others are each an —H group or a hydrocarbon group having 1 to 20 carbon atoms, A is an unsaturated bond or an alkylene group having 1 to 20 carbon atoms and optionally having an —H group, a —CH₃ group, an —NH₂ group, an —O— group, or an —OH group, n is an integer of 0 to 10, and B is a —COOH group, an —OH group, or an ═O group and optionally forms a ring structure with adjacent R₁ or R₅.

### BACKGROUND OF THE INVENTION

### Field of the Invention

The present invention relates to a rubber composition for a tire side wall and a pneumatic tire comprising a side wall portion containing a vulcanized rubber of the rubber composition for a tire side wall.

### Description of the Related Art

Recently, low fuel consumption is required for pneumatic tires from the viewpoint of energy saving. And, there is maneuvering stability in one of required performance of pneumatic tires. One of the methods for improving the former is to improve the low heat build-up property of the vulcanized rubber, and one of the methods for improving the latter is to increase the rigidity of the vulcanized rubber even under a high temperature (high hardness)

Incidentally, Patent Document 1 below describes a rubber composition containing a predetermined amount of a specific compound per 100 parts by mass of the total amount of the rubber component for the purpose of improving heat aging resistance of a vulcanized rubber.

### PRIOR ART DOCUMENT

### Patent Document

Patent Document 1: JP-A-2023-089553

### SUMMARY OF THE INVENTION

In order to achieve both low fuel consumption and maneuvering stability of pneumatic tires, it is crucial to optimize the loss-tangent (tanδ) and the hardness of the vulcanized rubber of the raw material rubber composition. Generally, low fuel consumption is highly dependent on tanδ at 60° C. (hereafter referred to as tanδ (60° C.)) for the raw material rubber composition, and a smaller tanδ (60° C.) is superior in low fuel consumption of pneumatic tires. In addition, when rubber hardness of the vulcanized rubber is high, maneuvering stability of pneumatic tires is excellent.

The vulcanized rubber of the rubber composition described in Patent Document 1 is excellent in heat aging resistance, but as a result of intensive studies by the present inventors, it has been found that there is room for further improvement in terms of low fuel consumption and maneuvering stability in order to use the vulcanized rubber as a rubber part of a pneumatic tire.

In view of the above circumstances, it is an object of the present invention to provide a rubber composition for a tire side wall which becomes a raw material of a tire side wall having improved low fuel consumption and maneuvering stability when used as a tire side wall of a pneumatic tire.

Further, an object of the present invention is to provide a pneumatic tire having a tire side wall with improved low fuel consumption and maneuvering stability in a well-balanced manner.

The above object can be achieved by the present invention as described below. Specifically, the present invention relates to a rubber composition for tire side wall comprising, per 100 parts by mass of a rubber component containing at least a diene-based rubber, 0.2 to 7 parts by mass of a compound represented by the following general formula (1):

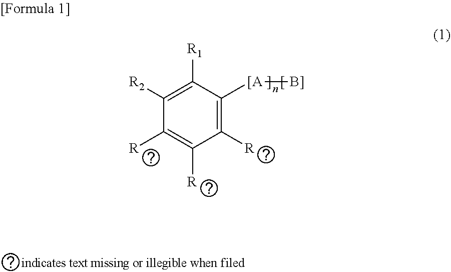

wherein at least one of R₁ to R₅ is an —OH group or an —OCH₃ group and others are each an —H group or a hydrocarbon group having 1 to 20 carbon atoms, A is an unsaturated bond or an alkylene group having 1 to 20 carbon atoms and optionally having an —H group, a —CH₃ group, an —NH₂ group, an —O— group, or an —OH group, n is an integer of 0 to 10, and B is a —COOH group, an —OH group, or an ═O group and optionally forms a ring structure with adjacent R₁ or R₅.

The rubber composition for tire side wall (1) is preferably a rubber composition for tire side wall (2) containing less than 50 parts by mass of carbon black per 100 parts by mass of the rubber component.

The rubber composition for tire side wall (1) or (2) is preferably a rubber composition for tire side wall (3) containing 30 to 70 parts by mass of natural rubber and 30 to 70 parts by mass of butadiene rubber per 100 parts by mass of the rubber component.

Any one of the rubber compositions for tire side wall (1) to (3) is preferably a rubber composition for tire side wall (4) in which the compound represented by the general formula (1) is a naturally occurring compound.

Any one of the rubber compositions for tire side wall (1) to (4) is preferably a rubber composition for tire side wall (5) in which the compound represented by the general formula (1) is at least one of 3,4-dihydroxycinnamic acid and 3,4-dimethoxycinnamic acid.

The present invention also relates to a pneumatic tire comprising a side wall portion containing a vulcanized rubber of any one of the rubber compositions for tire side wall (1) to (5).

The rubber compositions for tire side wall according to the present invention contains 0.2 to 7 parts by mass of the compound represented by the general formula (1) per 100 parts by mass of a rubber component containing at least a diene-based rubber. As a result, low fuel consumption and maneuvering stability of the finally produced vulcanized rubber are dramatically improved. The reason for achieving such an effect is considered as follows.

The compound represented by the general formula (1) has high hydrophilicity, and thus tends to aggregate in the rubber composition, so that the viscosity of the rubber composition for tire side wall increases. Therefore, a high shear state of the rubber composition can be maintained while suppressing an excessive temperature increase during rubber kneading. As a result, the reaction between the compound represented by the general formula (1) and the rubber component proceeds at a high level. Thus, the rubber hardness of the finally obtained vulcanized rubber is increased and tanδ at 60° C. (tanδ (60° C.)) is lowered. Consequently, low fuel consumption and maneuvering stability of vulcanized rubber may be further improved.

### DETAILED DESCRIPTION OF THE PREFERRED EMBODIMENTS

The rubber composition for tire side wall according to the present invention contains, per 100 parts by mass of the rubber component containing at least a diene-based rubber, 0.2 to 7 parts by mass of a compound represented by the following general formula (1):

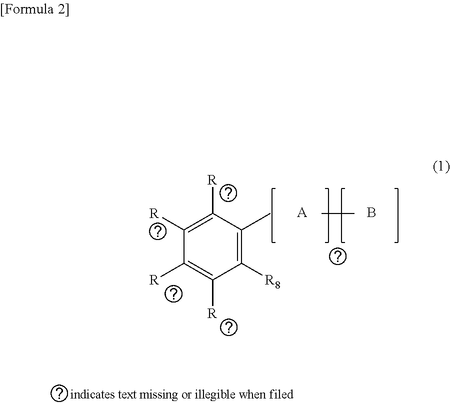

wherein at least one of R₁ to R₅ is an —OH group or an —OCH₃ group and others are each an —H group or a hydrocarbon group having 1 to 20 carbon atoms, A is an unsaturated bond or an alkylene group having 1 to 20 carbon atoms and optionally having an —H group, a —CH₃ group, an —NH₂ group, an —O— group, or an —OH group, n is an integer of 0 to 10, and B is a —COOH group, an —OH group, or an ═O group and optionally forms a ring structure with adjacent R₁ or R₅. The content of the compound represented by the general formula (1) is more preferably 0.5 to 5 parts by mass per 100 parts by mass of the total amount of the rubber component.

The use of a naturally occurring compound as the compound represented by the general formula (1) is more preferred in terms of environmental protection. Examples of the naturally occurring compound include 3,4-dihydroxycinnamic acid (caffeic acid), 3,4-dimethoxycinnamic acid, curcumin, sesamol, coumaric acid, ferulic acid, sinapinic acid, chlorogenic acid, rosmarinic acid, 4-(4-hydroxy-3-methoxyphenyl)-2-butanone, naringin, hesperidin, quercetin, and tocopherol. In the present invention, among these compounds, at least one of 3,4-dihydroxycinnamic acid (caffeic acid) and 3,4-dimethoxycinnamic acid is more preferably used from the viewpoint of improving the low fuel consumption and the maneuvering stability of the vulcanized rubber. The reason why the use of at least one of 3,4-dihydroxycinnamic acid and 3,4-dimethoxycinnamic acid improves the low fuel consumption and the maneuvering stability of the vulcanized rubber is not known, but there may be, for example, the following reasons (1) to (3).
(1) When 3,4-dihydroxycinnamic acid and/or 3,4-dimethoxycinnamic acid are added together with a zinc compound such as zinc oxide to the rubber composition for tire side wall used as a raw material, two or more molecules of 3,4-dihydroxycinnamic acid or 3,4-dimethoxycinnamic acid coordinate to zinc through hydroxy groups or methoxy groups at R₂ and R₃ positions in the rubber composition so that the molecular weight increases due to the formation of a complex;
(2) when two or more molecules of 3,4-dihydroxycinnamic acid or 3,4-dimethoxycinnamic acid form a complex, the tendency to aggregate in the rubber composition for tire side wall is further enhanced, so that the viscosity of the rubber composition for tire side wall is more effectively increased.
   As a result of more effective increase in viscosity of the rubber composition for tire side wall, the reaction of the compound described in the above general formula (1) with the rubber component proceeds more effectively, so that the rubber hardness of the finally obtained vulcanized rubber becomes high and tanδ at 60° C. (tanδ (60° C.)) is lowered. As a result, the vulcanized rubber finally obtained improves both the low fuel consumption and the maneuvering stability in good balance

It is to be noted that a non-naturally occurring compound may be also used as the compound represented by the general formula (1). Examples of the non-naturally occurring compound include 2,3-dimethoxycinnamic acid, 2,4-dimethoxycinnamic acid, 2,5-dimethoxycinnamic acid, 2,3,4-tritoxycinnamic acid, 3,4,5-tritoxycinnamic acid, protocatechuic acid, 3-(3,4-dihydroxyphenyl)-L-alanine, 5,5′,6,6′-tetrahydroxy-3,3,3′,3′-tetramethyl-1,1′-spirobiindane, carvacrol, 3,4-dimethoxyhydrocinnamic acid, 5,6-dimethoxy-1-indanone, and 3,4-dihydroxyhydrocinnamic acid.

As the rubber component, for example, a diene-based rubber can suitably be used. In the present invention, the diene-based rubber is preferably natural rubber (NR) and butadiene rubber (BR). The content of natural rubber is preferably 30 to 70 parts by mass and the content of butadiene rubber is preferably 30 to 70 parts by mass by mass per 100 parts by mass of the diene-based rubber. The rubber composition for tire side wall according to the present invention may contain other than natural rubber and butadiene rubber, for example isoprene rubber (IR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber.

The rubber composition for tire side wall according to the present invention may contain, as a filler, carbon black. Examples of the carbon black that can be used include: carbon blacks usually used in the rubber industry, such as SAF, ISAF, HAF, FEF, and GPF; and conductive carbon blacks such as acetylene black and ketjen black. The content of carbon black to be blended in the rubber composition for tire side wall is not particularly limited, but is preferably less than 50 parts by mass. The lower limit of the content of carbon black is not particularly limited, but is preferably 25 parts by mass per 100 parts by mass of the rubber component.

The rubber composition for tire side wall according to the present invention may contain, in addition to the rubber component, the compound represented by the general formula (1) and further carbon black, silica, silane coupling agent, vulcanizing agent, a vulcanization accelerator, an antiaging agent, stearic acid, a softener such as wax or oil, a processing aid, etc.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the sulfur is preferably 0.5 to 5 parts by mass per 100 parts by mass of the rubber component in the rubber composition according to the present invention.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination.

In the rubber composition for tire side wall according to the present invention, examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination.

The rubber composition for tire side wall according to the present invention is obtained by kneading the rubber component, the compound represented by the general formula (1), and further carbon black, silica, silane coupling agent, the vulcanizing agent, the vulcanization accelerator, the antiaging agent, stearic acid, the softener such as wax or oil, the processing aid, etc. with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

The vulcanized rubber of the rubber composition for tire side wall according to the present invention is excellent in low fuel consumption and maneuvering stability. Therefore, the rubber composition according to the present invention for tire side wall is useful as a raw material for a rubber part constituting a tire side wall part of a pneumatic tire.

### EXAMPLES

Hereinbelow, the configuration and effect of the present invention will be described with reference to specific examples etc.

### Preparation of Rubber Compositions

Rubber compositions of Examples 1 to 6 and Comparative Examples 1 to 4 were prepared according to formulations shown in Tables 1 to 2 and kneaded using a usual Banbury mixer. Compounding agents listed in Tables 1 to 2 are shown below (in Tables 1 to 2, the content of each of the compounding agents added is expressed in parts by mass per 100 parts by mass of the rubber component).
Natural rubber; RSS #3
Butadiene rubber; manufactured by Ube Corporation, trade name “UBEPOL BR150B”
Carbon black; manufactured by Tokai Carbon Co., Ltd., trade name “SEAST 3”
Aroma oil; manufactured by JX Nippon Oil & Energy Corporation, trade name “Process NC140”
Zinc white; manufactured by MITSUI MINING & SMELTING CO., LTD., trade name “Zinc white #1”
Stearic acid; manufactured by Kao Corporation, trade name “LUNAC S-20”
Antiaging agent; manufactured by Ouchi Shinko Chemical Industrial Co., Ltd., trade name: “Nocrac 6C”
3,4-Dimethoxycinnamic acid
3,4-Dihydroxycinnamic acid (caffeic acid)
Acetamide cinnamic acid (compound not corresponding to compound represented by general formula (1))
Sulfur; manufactured by Tsurumi Chemical Industry Co., ltd., trade name “Powder Sulfur”
Vulcanization accelerator; manufactured by Ouchi Shinko Chemical Industrial Co., Ltd., trade name “NOCCELER CZ”

The rubber hardness of vulcanized rubber (Hs.) of Examples 1 to 6 and Comparative Examples 1 to 3, and the tanδ (60° C.) of the vulcanized rubber of each of the rubber compositions of Examples 1 to 6 and Comparative Examples 1 to 3 were evaluated by the following methods.

### <Rubber Hardness of Vulcanized Rubber (Hs.)>

In the evaluation of the rubber hardness, in test pieces of sample rubbers obtained by heating and vulcanizing the rubber compositions of Examples 1 to 6 and Comparative Examples 1 to 3 at 160° C. for 30 minutes using a predetermined mold, the hardness at a temperature of 23° C. was measured by a durometer type A in accordance with JIS K6253, and expressed as an index when the value in Comparative Example 1 is 100. The larger the index is, the higher the rubber hardness is at room temperature, which indicates excellent steering stability when used in the tire side wall part of the pneumatic tire.

### <Tanδ (60° C.) of Vulcanized Rubber>

The rubber compositions of Examples 1 to 6 and Comparative Examples 1 to 3 were heated and vulcanized at 160° C. for 30 minutes using a predetermined mold, and the thus obtained sample rubbers were used as measurement samples. The storage elastic modulus (E′) and loss elastic modulus (E″) were measured for each measurement sample by a dynamic viscoelasticity measuring device (product name “Fully Automatic Viscoelasticity Analyzer VR-7110”, manufactured by Ueshima Seisakusho Co., Ltd.) to measure tanδ (60° C.). In Tables 1 to 2, the measured value was expressed as an index when the value of tanδ (60° C.) in Comparative Example 1 is 100. As for tanδ (60° C.), the smaller the index is, the better the low fuel consumption is when used in the tire side wall part of the pneumatic tire. Measurement conditions are as follows.
Size of measurement sample: length 40 mm, width 3 mm, thickness 2 mm
Measurement mode: Tensile mode
Measurement temperature: 0° C.
Frequency: 100 Hz
Dynamic strain: 0.15%

TABLE 1

| Comparative | Comparative | Comparative | | | |
|---|---|---|---|---|---|
| Example | Example | Example | Example | Example | Example |
| 1 | 2 | 3 | 1 | 2 | 3 |

(Formulation)

| | | | | | | |
|---|---|---|---|---|---|---|
| Butadiene rubber | 60 | 60 | 60 | 60 | 60 | 60 |
| Natural rubber | 40 | 40 | 40 | 40 | 40 | 40 |
| Carbon black | 50 | 30 | 42 | 47 | 42 | 38 |
| Aroma oil | 10 | 10 | 10 | 10 | 10 | 10 |
| Zinc white | 3 | 3 | 3 | 3 | 3 | 3 |
| Stearic acid | 2 | 2 | 2 | 2 | 2 | 2 |
| Antiageing agent | 2 | | | | | |
| 3,4-Dimethoxycinnamic acid | | 10 | | 0.5 | 2 | 5 |
| (compound not corresponding to | | | | | | |
| compound represented by general | | | | | | |
| formula (1)) | | | | | | |
| 3,4-Dihydroxycinnamic acid | | | | | | |
| (compound not corresponding to | | | | | | |
| compound represented by general | | | | | | |
| formula (1)) | | | | | | |
| Acetamide cinnamic acid | | | 2 | | | |
| (compound not corresponding to | | | | | | |
| compound represented by general | | | | | | |
| formula (1)) | | | | | | |
| Sulfur | 2 | 2 | 2 | 2 | 2 | 2 |
| Vulcanization accelerator | 1 | 1 | 1 | 1 | 1 | 1 |

(Physical properties (index))

| | | | | | | |
|---|---|---|---|---|---|---|
| Hs. | 100 | 99 | 95 | 100 | 100 | 101 |
| tanδ(60° C.) | 100 | 105 | 102 | 95 | 87 | 80 |

From the results shown in Table 1, it can be seen that, in the rubber composition for tire side wall of Comparative Example 2, since the blending amount of the 3,4-dimethoxycinnamic acid corresponding to the compound described in the general formula (1) is excessive, tanδ (60° C.) is deteriorated due to excessive aggregation of the 3,4-dimethoxycinnamic acid corresponding to the compound described in the general formula (1). In the vulcanized rubber of the rubber composition for tire side wall of Comparative Example 3, since the blended acetamido cinnamic acid is a compound which does not correspond to the compound described in the general formula (1), it is found that tanδ (60° C.) and rubber hardness deteriorate. On the other hand, it can be seen that vulcanized rubber in the tire side wall composition of Examples 1-3, when used in the tire side wall portion of the pneumatic tire, improves both tanδ (60° C.) and rubber hardness, resulting in a well-balanced improvement in both the low fuel consumption and the maneuvering stability.

TABLE 2

| | | | |
|---|---|---|---|
| Comparative | | | |
| Example 1 | Example 4 | Example 5 | Example 6 |

(Formulation)

| | | | | |
|---|---|---|---|---|
| Butadiene rubber | 60 | 60 | 50 | 60 |
| Natural rubber | 40 | 40 | 50 | 40 |
| Carbon black | 50 | 44 | 40 | 45 |
| Aroma oil | 10 | 10 | 10 | 10 |
| Zinc white | 3 | 3 | 3 | 3 |
| Stearic acid | 2 | 2 | 2 | 2 |
| Antiageing agent | 2 | | | 1 |
| 3,4-Dimethoxycinnamic | | | 2 | 1 |
| acid (compound not | | | | |
| corresponding to | | | | |
| compound represented | | | | |
| by general formula (1)) | | | | |
| 3,4-Dihydroxycinnamic | | 2 | | |
| acid (compound not | | | | |
| corresponding to | | | | |
| compound represented | | | | |
| by general formula (1)) | | | | |
| Acetamide cinnamic | | | | |
| acid (compound not | | | | |
| corresponding to | | | | |
| compound represented | | | | |
| by general formula (1)) | | | | |
| Sulfur | 2 | 2 | 2 | 2 |
| Vulcanization accelerator | 1 | 1 | 1 | 1 |

(Physical properties (index))

| | | | | |
|---|---|---|---|---|
| Hs. | 100 | 100 | 100 | 101 |
| tan δ (60° C.) | 100 | 89 | 86 | 98 |

From the results shown in Table 2, it can be seen that, as a result of blending the 3,4-dihydroxycinnamic acid corresponding to the compound described in the general formula (1), the vulcanized rubber of the rubber composition of Example 4 improves both the low fuel consumption and the maneuvering stability in good balance due to the improvement in both the tanδ (60° C.) and the rubber hardness when used in the side wall portion of the pneumatic tire. The vulcanized rubber composition of tire-side walls of examples 5-6 is shown to be well balanced in terms of both the low fuel consumption and the maneuvering stability due to the improvement in both tanδ (60° C.) and rubber hardness when used on tire side wall of the pneumatic tire.

What is claimed is:

1. A rubber composition for tire side wall comprising, per 100 parts by mass of a rubber component containing at least a diene-based rubber, 0.2 to 7 parts by mass of a compound represented by the following general formula (1): 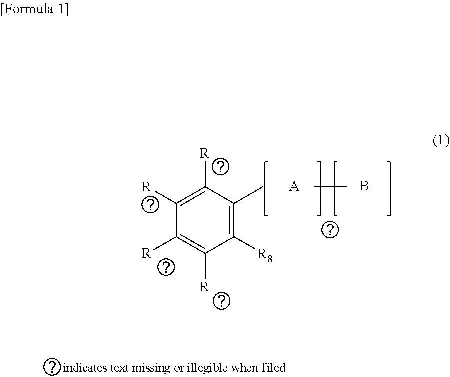
wherein at least one of R₁ to R₅ is an —OH group or an —OCH₃ group and others are each an —H group or a hydrocarbon group having 1 to 20 carbon atoms, A is an unsaturated bond or an alkylene group having 1 to 20 carbon atoms and optionally having an —H group, a —CH₃ group, an —NH₂ group, an —O— group, or an —OH group, n is an integer of 0 to 10, and B is a —COOH group, an —OH group, or an ═O group and optionally forms a ring structure with adjacent R₁ or R₅.

2. The rubber composition for tire side wall according to claim 1, comprising less than 50 parts by mass of carbon black per 100 parts by mass of the rubber component.

3. The rubber composition for tire side wall according to claim 1, comprising 30 to 70 parts by mass of natural rubber and 30 to 70 parts by mass of butadiene rubber per 100 parts by mass of the rubber component.

4. The rubber composition for tire side wall according to claim 1, wherein the compound represented by the general formula (1) is a naturally occurring compound.

5. The rubber composition for tire side wall according to claim 1, wherein the compound represented by the general formula (1) is at least one of 3,4-dihydroxycinnamic acid and 3,4-dimethoxycinnamic acid.

6. A pneumatic tire comprising a side wall portion containing a vulcanized rubber of the rubber composition according to claim 1.
